(19) United States
(12) Patent Application Publication
(10) Pub. No.: US 2026/0342124 A1
(43) Pub. Date: Oct. 29, 2026

(54) STORAGE BATTERY CONTROL DEVICE AND ELECTRICITY STORAGE SYSTEM

(71) Applicant: YAZAKI CORPORATION, Tokyo (JP)

(72) Inventor: Takahiro Syouda, Susono-shi (JP)

(21) Appl. No.: 19/707,221

(22) Filed: Jun. 12, 2026

Related U.S. Application Data
(63) Continuation of application No. PCT/JP2024/043549, filed on Dec. 10, 2024.

(30) Foreign Application Priority Data
Jan. 10, 2024 (JP) 2024-001574

(51) Int. Cl. H02J 7/96; H01M 10/42; H01M 10/48; H01M 50/51; H02J 7/40; H02J 7/50

(52) U.S. Cl. CPC H02J 7/96; H01M 10/425; H01M 10/482; H01M 50/51; H02J 7/40; H02J 7/50; H02J 2207/20

(57) ABSTRACT

An MCU of a module interface receives a detection signal of a cell voltage from a cell monitoring unit, and transmits a charge reduction signal for reducing charge power of a string to an MCU of a power converter when the cell voltage is equal to or larger than an upper limit threshold value. The MCU controls the power converter to bring the charge power of the string close to a charge power instruction value while a control signal is received from a string controller and a charge reduction signal is not received from the MCU, and controls the power converter to bring the charge power of the string close to the charge power instruction value while the control signal is received from the string controller and the charge reduction signal is received from the MCU.

### CROSS-REFERENCE TO RELATED APPLICATIONS

The present application is a continuation application of PCT/JP2024/043549 that claims priority to Japanese Patent Application No. 2024-001574 filed on Jan. 10, 2024, the entire content of which is incorporated herein by reference.

### TECHNICAL FIELD

The present disclosure relates to a storage battery control device and an electricity storage system.

### BACKGROUND ART

As an electricity storage system including a string in which a plurality of storage battery modules are connected in series, there is known an electricity storage system including a bypass mechanism that bypasses the respective storage battery modules (for example, see JP2013-31247A and JP2013-31249A). In the electricity storage system described in JP2013-31247A and JP2013-31249A, a fully charged or fully discharged storage battery module can be bypassed using the bypass mechanism, allowing the charge and discharge to continue. Therefore, storage battery modules having different charge and discharge capacities due to a difference in deterioration state or a difference in type may be mixed.

In new storage battery modules whose performance variations during manufacturing are prevented or storage battery modules that have reached a similar state of deterioration due to use under the same environment and condition, voltages of all storage battery cells in a string can be kept within an appropriate range by monitoring the total voltage or the total current of the string and controlling the charge and discharge of the string. However, in storage battery modules having performance variations during manufacturing or storage battery modules having different deterioration states due to not being used in the same environment or the same condition, the performance of the storage battery cell in the storage battery module also varies in many cases. In a case in which storage battery modules having variations in the performance of the storage battery cells are mixed, it is difficult to control the voltages of all the storage battery cells not to exceed an upper limit value and not to fall below a lower limit value only by monitoring the total voltage or the total current of the string and controlling the charge and discharge of the string.

Therefore, in an electricity storage system including a string in which storage battery modules having variations in the performance of storage battery cells are mixed, it is necessary to control the charge and discharge of the string by monitoring a voltage of the storage battery cell (hereinafter, referred to as a cell voltage). However, when cell voltage information is transmitted from a cell voltage monitoring unit to a controller that controls the charge and discharge of the string via an interface of the storage battery module, the controller determines whether the cell voltage is between the upper limit value and the lower limit value, and transmits a control signal based on the determination result to a power converter of the string, the delay of the series of communication becomes large, and the cell voltage may exceed the upper limit value or fall below the lower limit value during the delay.

### SUMMARY OF INVENTION

The present disclosure provides a storage battery control device and an electricity storage system capable of keeping voltages of storage battery cells in a storage battery module within an appropriate range regardless of whether there is variation in performance of the storage battery cells in a string.

According to an illustrative aspect of the present disclosure, there is provided a storage battery control device for controlling an electricity storage system, the electricity storage system including a string including a plurality of storage battery modules connected in series, and a power converter configured to convert charge and discharge power of the string, the storage battery modules each including a plurality of storage battery cells connected in series, and a cell voltage detection unit configured to detect a voltage of each of the storage battery cells. The storage battery control device includes: a plurality of module control units provided respectively corresponding to the storage battery modules, and configured to control the storage battery modules; a power converter control unit configured to control the power converter; and a string control unit provided corresponding to the string, and configured to communicate with the plurality of module control units, the power converter control unit, and a host control unit, and transmit a control signal to the power converter control unit for controlling the power converter such that charge power of the string approaches a charge power instruction value received from the host control unit, in which each of the module control units is configured to receive a detection signal of the voltage of the storage battery cell from the cell voltage detection unit, and transmit a charge reduction signal for reducing the charge power of the string to the power converter control unit when the voltage of the storage battery cell is equal to or larger than an upper limit threshold value, and the power converter control unit is configured to control the power converter to bring the charge power of the string close to the charge power instruction value while receiving the control signal from the string control unit and not receiving the charge reduction signal from the module control unit, and control the power converter to reduce the charge power of the string while receiving the control signal from the string control unit and receiving the charge reduction signal from the module control unit.

According to another illustrative aspect of the present disclosure, there is provided a storage battery control device for controlling an electricity storage system, the electricity storage system including a string including a plurality of storage battery modules connected in series, and a power converter configured to convert charge and discharge power of the string, the storage battery modules each including a plurality of storage battery cells connected in series, and a cell voltage detection unit configured to detect a voltage of each of the storage battery cells. The storage battery control device includes: a plurality of module control units provided respectively corresponding to the storage battery modules, and configured to control the storage battery modules; a power converter control unit configured to control the power converter; and a string control unit provided corresponding to the string, and configured to communicate with the plurality of module control units, the power converter control unit, and a host control unit, and transmit a control signal to the power converter control unit for controlling the power converter such that discharge power of the string approaches a discharge power instruction value received from the host control unit, in which each of the module control units is configured to receive a detection signal of the voltage of the storage battery cell from the cell voltage detection unit, and transmit a discharge reduction signal for reducing the discharge power of the string to the power converter control unit when the voltage of the storage battery cell is equal to or less than a lower limit threshold value, and the power converter control unit is configured to control the power converter to bring the discharge power of the string close to the discharge power instruction value while receiving the control signal from the string control unit and not receiving the discharge reduction signal from the module control unit, and control the power converter to reduce the discharge power of the string while receiving the control signal from the string control unit and receiving the discharge reduction signal from the module control unit.

According to another illustrative aspect of the present disclosure, there is provided an electricity storage system including: a string including a plurality of storage battery modules connected in series; a power converter configured to convert charge and discharge power of the string, the storage battery modules each including a plurality of storage battery cells connected in series, and a cell voltage detection unit configured to detect a voltage of each of the storage battery cells; and the storage battery control device as above.

According to the present disclosure, the voltages of the storage battery cells in the storage battery module can be kept within an appropriate range regardless of whether there is variation in the performance of the storage battery cells in the string.

### BRIEF DESCRIPTION OF DRAWINGS

FIG. 1 is a circuit diagram illustrating a configuration of a circuit of an electricity storage system including a storage battery control device according to an embodiment of the present disclosure;

FIG. 2 is a block diagram illustrating a configuration of a control of the electricity storage system illustrated in FIG. 1;

FIG. 3 is a graph illustrating update of an electricity storage system charge and discharge power instruction value and a string charge and discharge power instruction value of each string;

FIG. 4 is a graph illustrating update of the electricity storage system charge and discharge power instruction value and the string charge and discharge power instruction value of each string;

FIG. 5 is a circuit diagram illustrating a communication circuit for performing communication among a string controller, a power converter, and a module interface illustrated in FIGS. 1 and 2;

FIG. 6 is a chart illustrating a communication method of a storage battery control device according to a comparative example;

FIG. 7 is a chart illustrating a communication method of the storage battery control device illustrated in FIGS. 1 and 2;

FIG. 8 shows a graph illustrating a transition of a charge and discharge power instruction value and actual charge and discharge power, and timing charts respectively illustrating ON/OFF timings of a cell upper limit voltage warning signal and a cell lower limit voltage warning signal;

FIG. 9 is a flowchart illustrating a charge control of the storage battery control device illustrated in FIGS. 1 and 2; and

FIG. 10 is a flowchart illustrating a discharge control of the storage battery control device illustrated in FIGS. 1 and 2.

### DESCRIPTION OF EMBODIMENTS

Hereinafter, the present disclosure will be described with reference to a preferred embodiment. The present disclosure is not limited to the embodiment to be described below, and the embodiment can be appropriately modified without departing from the gist of the present disclosure. In the following described embodiment, a part of configurations may be not described or illustrated in the drawings, and regarding details of the omitted techniques, publicly known or well-known techniques are appropriately applied as long as there is no contradiction with contents described below.

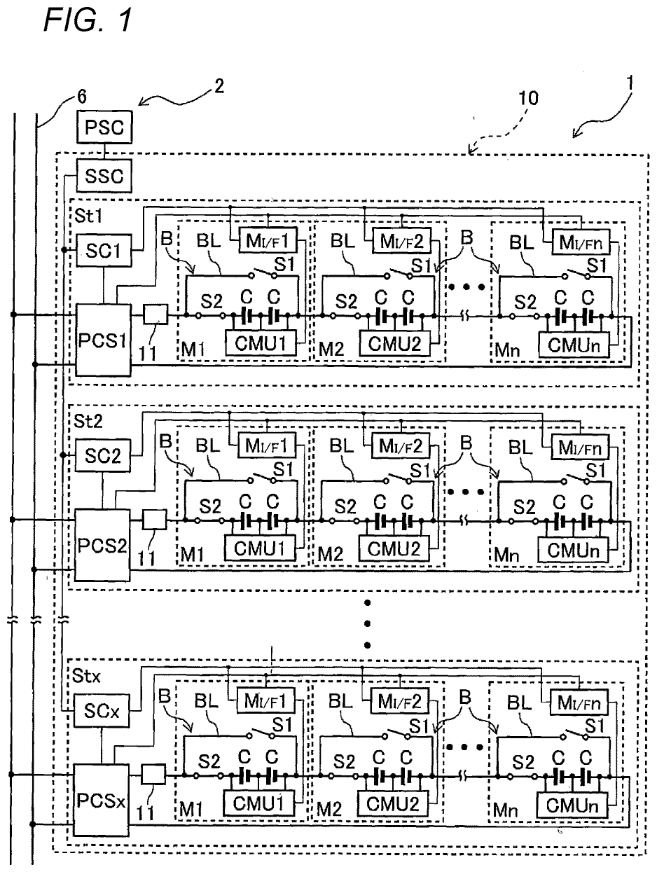

FIG. 1 is a circuit diagram illustrating a configuration of a circuit of an electricity storage system 1 including a storage battery control device 2 according to an embodiment of the present disclosure. The electricity storage system 1 illustrated in this drawing is a stationary power supply and includes a string system 10 and an electricity storage system controller PSC.

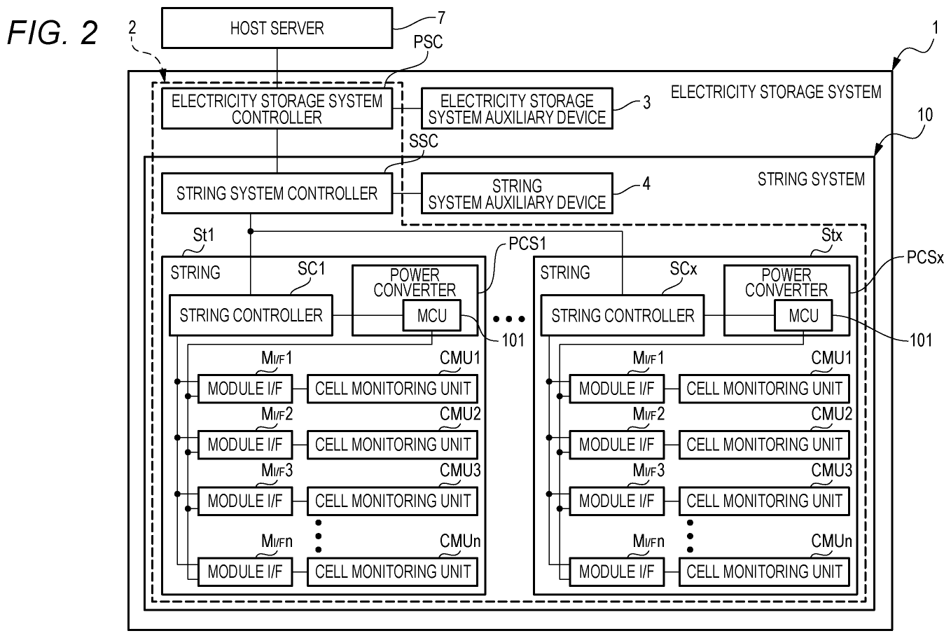

The electricity storage system controller PSC is a control device of the highest level in the electricity storage system 1, communicates with a host server 7 (see FIG. 2) and a string system controller SSC, and controls an electricity storage system auxiliary device 3 (see FIG. 2). In addition, the electricity storage system controller PSC includes a display input device (not illustrated) such as a touch panel having a display function and an input function.

The string system 10 includes a plurality of strings St1 to Stx, a string bus 6, the string system controller SSC, and a plurality of string controllers SC1 to SCx. The string system controller SSC and the string controllers SC1 to SCx will be described later. When it is not necessary to distinguish and describe the strings St1 to Stx, the strings St1 to Stx are referred to as strings St. When it is not necessary to distinguish and describe the string controllers SC1 to SCx, the string controllers SC1 to SCx are referred to as string controllers SC.

The plurality of strings St are connected in parallel to the string bus 6. The string bus 6 is connected to an external system (not illustrated). The strings St include power converters PCS1 to PCSx, respectively, and each of the strings St includes a plurality of modules M1 to Mn, and a plurality of module interfaces M_{I/F}1 to M_{I/F}n. The module interfaces M_{I/F}1 to M_{I/F}n will be described later. When it is necessary to distinguish and describe the power converters PCS1 to PCSx, the power converters PCS1 to PCSx are referred to as power converters PCS. When it is not necessary to distinguish and describe the modules M1 to Mn, the modules M1 to Mn are referred to as modules M. When it is not necessary to distinguish and describe the module interfaces M_{I/F}1 to M_{I/F}n, the module interface M_{I/F}1 to M_{I/F}n are referred to as module interfaces M_{I/F}.

The module M includes a storage battery including a plurality of storage battery cells C connected in series, and a bypass mechanism B, and the modules M include cell monitoring units CMU1 to CMUn, respectively. In the string St, a plurality of the storage batteries are connected in series, and the bypass mechanism B is provided for each storage battery. The string St includes a current sensor 11 that measures a total current of the string St, a voltage sensor (not illustrated) that measures a total voltage of the string St (hereinafter, referred to as a total string voltage), and the like.

The storage battery cells C are secondary batteries such as lithium ion batteries and lithium ion capacitors, are charged by power supplied from the external system through the power converters PCS, and supply power to the external system by discharging the charged power through the power converters PCS1 to PCSx. Although not particularly limited, the storage battery of the module M according to the present embodiment is obtained by recycling used storage batteries, and there are differences in the degree of deterioration and the performance of the storage battery cells.

The bypass mechanism B includes a bypass line BL, and switches S1 and S2. The bypass line BL is a power line that bypasses the storage battery. The switch S1 is provided on the bypass line BL. The switch S1 is, for example, a mechanical switch, a semiconductor switch, or a relay. The switch S2 is provided between a positive electrode of the storage battery and one end of the bypass line BL. The switch S2 is, for example, a mechanical switch, a semiconductor switch, or a relay.

The storage battery of the module M1 at a starting end and the storage battery of the module Mn at a terminal end are connected to the external system via the power converter PCS and the string bus 6. When the switch S1 is turned off and the switch S2 is turned on in all the bypass mechanisms B, all the storage batteries of the string St are connected in series to the external system. Meanwhile, when the switch S2 is turned off and the switch S1 is turned on in any one of the bypass mechanisms B, the storage battery corresponding to the bypass mechanism B is bypassed.

The power converter PCS is a bidirectional converter and is connected to the string bus 6. The power converter PCS is connected to a positive electrode of the storage battery of the module M1 at the starting end a negative electrode of the storage battery of the module Mn at the terminal end.

When the string St is charged, the power converter PCS converts a voltage received from the string bus 6 and transmits the converted voltage to the storage batteries of the plurality of modules M. Here, a voltage on a string St side changes according to a bypass state (the number of modules M in which the storage battery is bypassed) of the plurality of modules M and a charge state of the storage batteries of the plurality of modules M. Therefore, when the string St is charged, the power converter PCS converts the voltage received from the string bus 6 into the voltage on the string St side and transmits the converted voltage to the storage batteries of the plurality of modules M.

Meanwhile, when the string St is discharged, the power converter PCS converts voltages received from the storage batteries of the plurality of modules M and transmits the converted voltages to the string bus 6. Here, the voltages input to the power converter PCS during discharge change according to the bypass state of the plurality of modules M and the charge state of the storage batteries of the plurality of modules M. Accordingly, voltages input to the power converter PCS vary among the string St during discharge. Therefore, when the string St is discharged, the power converter PCS converts the input voltages into a voltage that matches the other strings St and outputs the converted voltage to the string bus 6. When the current flowing through the string bus 6 is an alternating current, the power converter PCS includes a synchronization unit for following a change in an instantaneous value.

The cell monitoring units CMU1 to CMUn each are connected between the positive and negative electrode terminals of each storage battery cell C, detects an inter-terminal voltage (hereinafter, referred to as a cell voltage) of each storage battery cell C, and transmits a detection signal to the module interface M_{I/F}. The cell monitoring units CMU1 to CMUn each have a cell balancing function and equalize the cell voltage of the module M. When it is not necessary to distinguish and describe the cell monitoring units CMU1 to CMUn, the cell monitoring units CMU1 to CMUn are referred to as cell monitoring units CMU.

The module interface M_{I/F} has a function of controlling the switches S1 and S2 of the bypass mechanism B and a function of communicating with the string controller SC and the power converter PCS. These functions will be described later.

FIG. 2 is a block diagram illustrating a configuration of a control of the electricity storage system 1 illustrated in FIG. 1. As illustrated in this drawing, the electricity storage system 1 includes the storage battery control device 2. The storage battery control device 2 includes the electricity storage system controller PSC, the string system controller SSC, the plurality of string controllers SC, the plurality of module interfaces M_{I/F}, the plurality of cell monitoring units CMU, and a plurality of micro control units (MCUs) 101. The cell monitoring unit CMU is provided for each module M, and the MCU 101 is provided for each power converter PCS.

The electricity storage system controller PSC, the string system controller SSC, the string controller SC, and the module interface M_{I/F} are provided for each level. The electricity storage system controller PSC corresponds to a level of the electricity storage system 1 of the highest order. The string system controller SSC corresponds to a level of the string system 10 subsequent to the level of the electricity storage system 1. The string controller SC corresponds to a level of the string St subsequent to the level of the string system 10. The module interface M_{I/F} corresponds to a level of the module M subsequent to the level of the string St.

The electricity storage system controller PSC communicates with the host server 7 and the string system controller SSC, and controls and manages the electricity storage system auxiliary device 3. The host server 7 is provided in a facility of an aggregator, a power receiving facility in a building or a factory, or the like. The host server 7 calculates a charge and discharge power instruction value for the entire electricity storage system 1 (hereinafter, referred to as an electricity storage system charge and discharge power instruction value) according to a state of the electricity storage system 1 and a power demand on a demand side, and transmits the charge and discharge power instruction value to the electricity storage system controller PSC.

Examples of the electricity storage system auxiliary device 3 include a temperature sensor that detects a temperature of an installation environment of the electricity storage system 1 (such as a container), and a fire extinguishing facility (all of which are not illustrated). In a case in which a detected value of the temperature sensor exceeds a threshold value, the electricity storage system controller PSC determines that the temperature of the installation environment of the electricity storage system 1 is abnormal, and transmits an abnormality notification to the display input device. In addition, the electricity storage system controller PSC monitors an operating state of the fire extinguishing system.

The electricity storage system controller PSC receives information on the state of the string St (hereinafter, referred to as string state information) and information on the state of the string system 10 (hereinafter, referred to as string system state information) from the string system controller SSC, and transmits the information to the host server 7 and the display input device.

Examples of the state of the string St include operation states such as charge, discharge, pause, and maintenance, the string current, the total string voltage, a state of charge (SOC) of the string St (hereinafter, referred to as a string SOC), a state of health (SOH) of the string St (hereinafter, referred to as a string SOH), and a limit value of charge and discharge power (or charge and discharge current) of the string St (hereinafter, referred to as a string charge and discharge power limit value).

Examples of the state of the string system 10 include a current of the string bus 6 (see FIG. 1) (hereinafter, referred to as a string bus current), a voltage of the string bus 6 (hereinafter, referred to as a string bus voltage), an SOC of the string system 10 (hereinafter, referred to as a string system SOC), an SOH of the string system 10 (hereinafter, referred to as a string system SOH), and a limit value of charge and discharge power (or charge and discharge current) of the string system 10 (hereinafter, referred to as a string system charge and discharge power limit value).

The electricity storage system controller PSC estimates the state of the electricity storage system 1 based on the string state information and the string system state information received from the string system controller SSC. Examples of the state of the electricity storage system 1 include operation states such as charge, discharge, pause, and maintenance, an SOC of the electricity storage system 1 (hereinafter, referred to as an electricity storage system SOC), and an SOH of the electricity storage system 1 (hereinafter, referred to as an electricity storage system SOH). The electricity storage system controller PSC outputs information on the estimated state of the electricity storage system 1 to the display input device as necessary. In the present embodiment in which the string system 10 is single, the string system SOC is equal to the electricity storage system SOC, and the string system SOH is equal to the electricity storage system SOH.

The electricity storage system controller PSC transmits information required for processing of the host server 7 to the host server 7. Examples of the information required for the processing of the host server 7 include the electricity storage system SOC, the electricity storage system SOH, and the string system charge and discharge power limit value. Here, the host server 7 determines a charge and discharge instruction corresponding to the electricity storage system 1 based on the “information required for the processing of the host server 7” received from the electricity storage system controller PSC, and transmits the charge and discharge instruction to the electricity storage system controller PSC. Examples of the charge and discharge instruction include, in addition to the electricity storage system charge and discharge power instruction value, control amounts in a constant voltage (CV) mode, a constant current (CC) mode, and a constant power (CP) mode, and an operation method such as a self-sustained operation or a system interconnection.

The electricity storage system controller PSC transmits various kinds of instruction information input by an operator or the like through the display input device to the string system controller SSC. Examples of the various kinds of instruction information that can be input through the display input device include information of an instruction to execute a maintenance and stop mode (hereinafter, referred to as a maintenance and stop instruction), an instruction to forcibly execute charge and discharge, and an instruction to forcibly execute state estimation.

Examples of the maintenance and stop instruction include an instruction to forcibly cause the electricity storage system auxiliary device 3, a string system auxiliary device 4, and an auxiliary device of the string St such as the power converter PCS to operate. By forcibly causing the electricity storage system auxiliary device 3, the string system auxiliary device 4, and the auxiliary device of the string St to operate, operations of the electricity storage system auxiliary device 3, the string system auxiliary device 4, and the auxiliary device of the string St can be confirmed.

Examples of the instruction to forcibly execute charge and discharge include an instruction to specify a predetermined charge and discharge amount and forcibly cause the electricity storage system 1 to execute charge and discharge. By specifying the predetermined charge and discharge amount and forcibly causing the electricity storage system 1 to execute the charge and discharge, whether the electricity storage system 1 can charge and discharge the specified predetermined charge and discharge amount can be confirmed.

Examples of the instruction to forcibly execute the state estimation include an instruction to specify a predetermined item of state estimation and forcibly cause the electricity storage system 1 to execute the state estimation. By specifying the predetermined item of the state estimation and forcibly causing the electricity storage system 1 to execute the state estimation, for example, the item of the state estimation such as the string system SOH and the electricity storage system SOH can be acquired at any timing.

The string system controller SSC communicates with the electricity storage system controller PSC and the plurality of string controllers SC, and controls and manages the string system auxiliary device 4. Examples of the string system auxiliary device 4 include a temperature sensor that detects an atmospheric temperature, a cooling device in the string system 10, a disconnecting device of the string bus 6, a current sensor that detects the string bus current, and a voltage sensor that detects the string bus voltage (all of which are not illustrated).

The string system controller SSC receives the string state information from the plurality of string controllers SC. Examples of the states of the strings St include operation states such as charge, discharge, pause, and maintenance, the string current, the total string voltage, the string SOC, the string SOH, the string charge and discharge power limit value, and a state of the string system auxiliary device 4. Examples of the state of the string system auxiliary device 4 include the string bus current and the string bus voltage.

The string system controller SSC estimates the state of the string system 10 based on the string state information received from the plurality of string controllers SC. Examples of the state of the string system 10 include the string bus current, the string bus voltage, the string system SOC, the string system SOH, and the string system charge and discharge power limit value. The state of the string system 10 may be estimated by the electricity storage system controller PSC.

For example, in a case in which detected values of the temperature sensor, the current sensor, and the voltage sensor or an estimated value of the state of the string system 10 are out of a range of a threshold value, the string system controller SSC determines that the string system 10 is abnormal, and stops the operation of the string system 10, or transmits an abnormality notification to the electricity storage system controller PSC.

The string system controller SSC transmits, to the electricity storage system controller PSC, information required for the processing of the electricity storage system controller PSC among information received from the plurality of string controllers SC and information estimated by the string system controller SSC. Examples of the information required for the processing of the electricity storage system controller PSC include the string system SOC, the string system SOH, and the string system charge and discharge power limit value.

Here, the electricity storage system controller PSC determines an instruction corresponding to the string system 10 based on the “information required for the processing of the electricity storage system controller PSC” received from the string system controller SSC, and transmits the instruction information to the string system controller SSC. Examples of the instruction include a charge and discharge instruction for the string system 10 in a charge and discharge mode, an instruction to individually control each unit of the string system 10 (hereinafter, referred to as an individual control instruction) in a maintenance mode, and a state estimation instruction for the string system 10 in a state estimation mode. Examples of the charge and discharge instruction for the string system 10 in the charge and discharge mode include, in addition to the string charge and discharge power instruction value assigned to each of the strings St, control amounts in a slope control mode to be described later, the constant voltage (CV) mode, the constant current (CC) mode, and the constant power (CP) mode, and the operation method such as a self-sustained operation or a system interconnection. The charge and discharge instruction for the string system 10 in the charge and discharge mode is transmitted from the electricity storage system controller PSC to the string controller SC via the string system controller SSC. Examples of the individual control instruction for the string system 10 in the maintenance mode include an instruction to individually control the power converter PCS, the switches S1 and S2 of the bypass mechanism B, and the string system auxiliary device 4. Examples of the state estimation instruction for the string system 10 in the state estimation mode include an execution instruction of a predetermined control required for executing the state estimation of the string St.

The string system controller SSC receives the above-described instruction corresponding to the string system 10 from the electricity storage system controller PSC, and determines whether the operation state of the string system 10 needs to be updated by comparing the currently received instruction with the previously received instruction. In a case in which it is determined that the operation state of the string system 10 needs to be updated, the string system controller SSC determines an operation mode of the string St, permission for a bypass request from the string controller SC, and the string charge and discharge power instruction value assigned to the string St. Examples of the operation mode of the string St include the charge and discharge mode, the state estimation mode, and the maintenance and stop mode.

The string controller SC communicates with the string system controller SSC and the plurality of module interfaces M_{I/F}, and controls and manages auxiliary device of the string St such as the power converter PCS. Examples of auxiliary device of the string St include, in addition to the power converter PCS, the current sensor 11 (see FIG. 1) that detects the string current, a voltage sensor (not illustrated) that detects a total string voltage, and a switch (not illustrated) that connects and disconnects the string St.

The string controller SC receives information on the state of the module M (hereinafter, referred to as module state information) from the module interface M_{I/F}. Examples of the module state include the temperature, current, voltage, and cell voltage of the module M, and the state of the bypass mechanism B.

The string controller SC estimates an SOC, an SOH, a charge and discharge power limit value, and the like of the storage battery of the module M based on the module state information received from the module interface M_{I/F}. The estimation of the SOC, the SOH, the charge and discharge power limit value, and the like of the storage battery of the module M may be executed by the module interface M_{I/F}. In this case, the module interface M_{I/F} may transmit the estimation result to the string controller SC.

The string controller SC estimates the state of the string St based on the module state information received from the module interface M_{I/F}. Examples of the state of the string St include the string SOH, the string SOC, and the string charge and discharge power limit value. The estimation of the state of the string St may be executed by the string system controller SSC. In this case, the string controller SC may transmit the module state information and an estimation result of the state of the storage battery to the string system controller SSC.

When the cell voltage, the total string current, the estimated value of the state of the string St, or the like is out of the threshold value range, the string controller SC determines that the string St is abnormal. In this case, the string controller SC stops the operation of the string St, or transmits an abnormality notification to the string system controller SSC.

The string controller SC transmits, to the string system controller SSC, information required for the processing of the string system controller SSC among the information received from the module interface M_{I/F} and the information estimated by the string controller SC. Examples of the information required for the processing of the string system controller SSC include the temperature, the current, the voltage, the SOC, the SOH, the charge and discharge power limit value, and the cell voltage of the storage battery of the module M, the state of the bypass mechanism B, the string SOC, the string SOH, and the string charge and discharge power limit value.

The string system controller SSC determines an instruction for each string St based on the “information required for the processing of the string system controller SSC” received from the string controller SC, and transmits instruction information to the string controller SC. Examples of the instruction include a charge and discharge instruction for the string St in the charge and discharge mode, an individual control instruction for the string St in the maintenance mode, and a state estimation instruction for the string St in the state estimation mode. Examples of an item of the charge and discharge instruction for the string St in the charge and discharge mode include, in addition to the string charge and discharge power instruction value, the control amounts in the constant voltage mode, the constant current mode, and the constant power mode, and the operation method such as a self-sustained operation or a system interconnection. Examples of the item of the individual control instruction for the string St in the maintenance mode include an instruction to individually control the bypass mechanism B. Examples of an item of the state estimation instruction in the state estimation mode include executing charge and discharge at a constant current and recording the voltage of the storage battery at that time.

The string controller SC receives the above-described instruction information for each string St from the string system controller SSC, and determines whether a bypass schedule of the string St needs to be updated by comparing the currently received instruction information with the previously received instruction information. The bypass schedule of the string St is a plan related to the bypass of the storage battery executed by the bypass mechanism B, and is determined based on a predetermined criterion. The string controller SC determines whether switching of charge to discharge or discharge to charge is executed in the string St, and determines that the bypass schedule needs to be updated in a case in which the switching is executed. In a case in which the bypass schedule needs to be updated, the string controller SC determines the bypass schedule of the storage battery based on storage battery state information received from the module interface M_{I/F} and an estimation result of the state of the storage battery.

Meanwhile, the string controller SC determines whether string charge and discharge power needs to be controlled by comparing the current and previous module state information received from the module interface M_{I/F} and the current and previous estimation results of the state of the storage battery. In a case in which the string charge and discharge power needs to be controlled, the string controller SC transmits a control signal corresponding to the string charge and discharge power instruction value received from the string system controller SSC to the MCU 101 which is a control device of the power converter PCS.

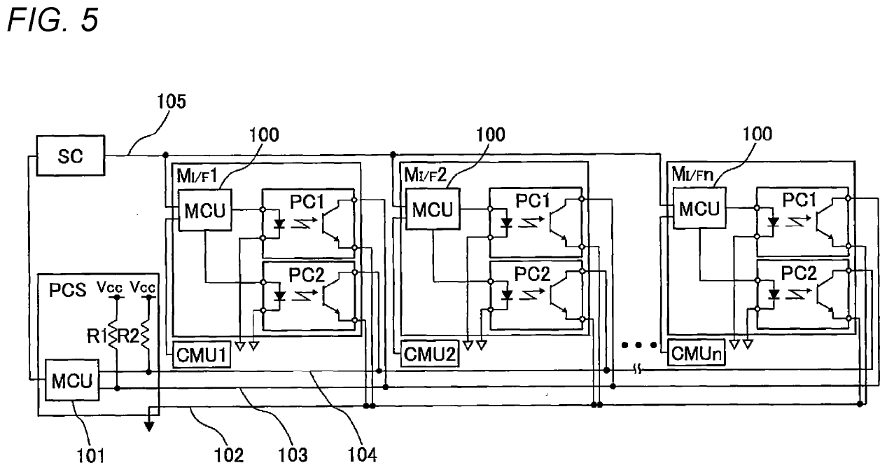

Here, the MCU 101 of the power converter PCS and an MCU 100 which is a control device included in the module interface M_{I/F} are connected by dedicated signal lines 102, 103, and 104 (see FIG. 5). When the cell voltage exceeds an upper limit threshold value, a charge reduction signal (a cell upper limit voltage warning signal described later) instructing reduction of charge power is transmitted from the MCU 100 of the module interface M_{I/F} to the MCU 101 of the power converter PCS. When the cell voltage falls below a lower limit threshold value, a discharge reduction signal (a cell lower limit voltage warning signal described later) instructing reduction of discharge power is transmitted from the MCU 100 of the module interface M_{I/F} to the MCU 101 of the power converter PCS.

The MCU 101 of the power converter PCS controls the power converter PCS according to the control signal such that the charge and discharge power of the string St approaches the string charge and discharge power instruction value. However, when the charge reduction signal or the discharge reduction signal is transmitted while the control signal is transmitted, the MCU 101 of the power converter PCS prioritizes the charge reduction signal or the discharge reduction signal and controls the power converter PCS such that the charge and discharge power of the string St is reduced. When the transmission of the charge reduction signal or the discharge reduction signal is stopped, the MCU 101 of the power converter PCS controls the power converter PCS according to the control signal such that the charge and discharge power of the string St approaches the string charge and discharge power instruction value.

In a case in which the maintenance and stop instruction is received from the string system controller SSC, the string controller SC analyzes the received maintenance and stop instruction and determines a type of maintenance to be executed. Examples of the type of the maintenance include an individual control, self-diagnosis, and replacement of the storage battery (hereinafter, referred to as storage battery replacement).

Examples of the individual control include a control for individually turning on and off a cooling device in the string St. Examples of the self-diagnosis include executing abnormality determination for determining an abnormality that determination is difficult to be executed during operation in the state estimation mode or the charge and discharge mode. Examples of the abnormality determination include performing a special control on the power converter PCS and the like, the switches S1 and S2 of the bypass mechanism B, and the like, acquiring responses thereof by various sensors, and determining the presence or absence of an abnormality. Examples of the storage battery replacement include guiding the storage battery replacement for the module M in which progress of deterioration, failure, or the like occurs. When the storage battery replacement is executed, a work guide is displayed on the display input device of the electricity storage system controller PSC, and a necessary control such as stopping the string St to be subjected to the storage battery replacement is executed in the electricity storage system 1.

In a case in which the state estimation instruction is received from the string system controller SSC, the string controller SC compares the currently received string charge and discharge power instruction value with the previously received string charge and discharge power instruction value, and determines whether there is a change. When the state estimation instruction is received from the string system controller SSC and there is a change in the previous and current string charge and discharge power instruction values, the string controller SC controls the power converter PCS and the switches S1 and S2 of the bypass mechanism B by a predetermined method so that the state of the string St can be estimated. Examples of the control method of the power converter PCS or the like when the state estimation mode is executed include a method of performing a constant current control on the power converter PCS. In addition, examples of the control method of the switches S1 and S2 of the bypass mechanism B when the state estimation mode is executed include a method of sequentially bypassing the storage battery of the module M which is fully discharged at the time of discharge.

The string controller SC records the module state information received from the module interface M_{I/F}. In addition, the string controller SC updates parameters used when the state estimation is executed as necessary based on the module state information received from the module interface M_{I/F}. Examples of the parameters include the SOH of the storage battery of the module M, a map of a charge and discharge limit value of the storage battery of the module M, and an SOC-open circuit voltage (OCV) characteristic.

The module interface M_{I/F} communicates with the string controller SC and the cell monitoring unit CMU. The MCU 100 controls the switches S1 and S2 of the bypass mechanism B, the cell monitoring unit CMU, and the like. The module interface M_{I/F} receives the module state information from the cell monitoring unit CMU or the like. Examples of the module state information include the total voltage of the storage battery of the module M, the temperature of the module M, and the cell voltage. The cell monitoring unit CMU receives detection signals from various sensors (not illustrated) such as a module voltage sensor that detects a voltage of the storage battery of the module M, a cell voltage sensor that detects the cell voltage, and a module temperature sensor that detects a temperature of the module M. The cell monitoring unit CMU may be configured as a single unit, or may be configured using a battery cell monitoring integrated circuit (IC) in the module interface M_{I/F}.

The module interface M_{I/F} receives the module state information from the cell monitoring unit CMU, and the MCU 100 estimates the state of the storage battery of the module M based on the received information. Examples of the state of the storage battery of the module M to be estimated include the SOC, the SOH, and the charge and discharge power limit value of the storage battery of the module M. The state of the storage battery of the module M may be estimated by the string controller SC.

For example, when the detected values of the module voltage sensor, the cell voltage sensor, and the module temperature sensor or the estimated value of the state of the storage battery of the module M are out of the threshold value range, the module interface M_{I/F} determines that the module M is abnormal. Then, the module interface M_{I/F} disconnects the switch S2 of the bypass mechanism B of the module M which is determined to be abnormal, or transmits an abnormality notification to the string controller SC. When the cell voltage exceeds the upper limit threshold value or falls below the lower limit threshold value, the cell upper limit voltage warning signal or the cell lower limit voltage warning signal described later is transmitted from the module interface M_{I/F} to the MCU 101 of the power converter PCS.

The module interface M_{I/F} transmits, to the string controller SC, information required for processing of a host controller such as the string controller SC among information received from the cell monitoring unit CMU and information estimated by the module interface M_{I/F}. Examples of the information required for the processing of the string controller SC include the temperature, the current, the voltage, the SOC, the SOH, the charge and discharge power limit value, and the cell voltage of the storage battery of the module M, and the states of the switches S1 and S2 of the bypass mechanism B.

Here, the string controller SC determines an instruction for each module M based on the “information required for the processing of the string controller SC” received from the module interface M_{I/F}, and transmits the instruction information to the module interface M_{I/F}. Examples of the instruction include a bypass control of the module M executed by the switches S1 and S2 of the bypass mechanism B, and a disconnection control of the storage battery of the module M executed by the switch S2 of the bypass mechanism B.

When there is a change in the previous and current instruction information received from the string controller SC, the MCU 100 of the module interface M_{I/F} controls the switches S1 and S2 of the bypass mechanism B to execute the bypass control or the disconnection control described above. In addition, in a case in which there is a change in the information received from the cell monitoring unit CMU and the information estimated by the module interface M_{I/F}, the module interface M_{I/F} executes an exception control which does not depend on the instruction from the host controller as necessary. The module interface M_{I/F} transmits an instruction to execute cell balancing of the storage battery of the module M to the cell monitoring unit CMU.

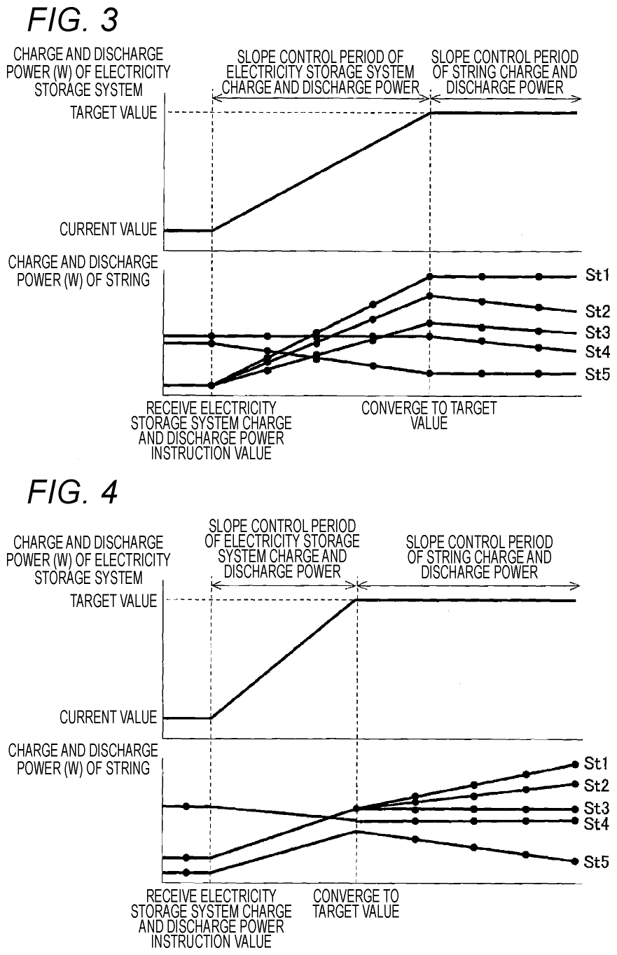

FIGS. 3 and 4 are graphs each illustrating update of the electricity storage system charge and discharge power instruction value and the string charge and discharge power instruction value assigned to each string St. As illustrated in the graphs, the electricity storage system charge and discharge power instruction value is updated so as to change from a current value to a target value over a predetermined period (a slope control period of the electricity storage system charge and discharge power in the drawing).

After the electricity storage system charge and discharge power instruction value is updated, the electricity storage system charge and discharge power instruction value is maintained, and the string charge and discharge power instruction value of each of the strings St updated. The string charge and discharge power instruction value of each of the strings St is updated so as to gradually change to a target value over a predetermined period (a slope control period of the string charge and discharge power in the drawing). The update of the string charge and discharge power instruction value of each of the strings St after the update of the electricity storage system charge and discharge power instruction value is executed for a purpose of adjusting a balance of the charge and discharge power between the strings St.

The graph in FIG. 3 illustrates, when a control (hereinafter, referred to as a standard slope control) of reducing a response speed of the update of the electricity storage system charge and discharge power instruction value is executed, a relation between the electricity storage system charge and discharge power instruction value, the string charge and discharge power instruction value of each of the strings St, and a time. The standard slope control is executed for the purpose of preventing a rapid change in the electricity storage system charge and discharge power at the time of the update of the electricity storage system charge and discharge power instruction value.

The graph in FIG. 4 illustrates, when a control (hereinafter, referred to as a shortest slope control) of increasing the response speed of updating the electricity storage system charge and discharge power instruction value is executed, a relation between the electricity storage system charge and discharge power instruction value, the string charge and discharge power instruction value of each of the strings St, and a time. The shortest slope control is executed for the purpose of high-speed response at the time of the update of the electricity storage system charge and discharge power instruction value.

As illustrated in the graph of FIG. 3, when the standard slope control is executed, the electricity storage system charge and discharge power instruction value changes from the current value to the target value over a longer slope control period (for example, 1.3 s to 30 s) than when the shortest slope control is executed. In this slope control period, the string charge power instruction value of each of the strings St is updated so as to gradually change from the current value to the target value.

Here, the electricity storage system charge and discharge power instruction value is a total value of the string charge and discharge power instruction values of the respective strings St. Therefore, the string system controller SSC determines the string charge and discharge power instruction value of each of the strings St such that the string charge and discharge power instruction value of each of the strings St gradually changes from the current value to the target value, and the total value of the string charge and discharge power instruction values of the respective strings St gradually changes from the current value to the target value of the electricity storage system charge and discharge power instruction value.

The string system controller SSC determines an individual target value of the string charge and discharge power instruction value for each of the strings St before the start of the slope control period of the electricity storage system charge and discharge power. In addition, the string system controller SSC individually calculates a change amount ΔP1 of the string charge and discharge power instruction value of each predetermined cycle (for example, a cycle of several seconds) for each of the strings St. The change amount ΔP1 is a value obtained by dividing a difference between the current value and the target value of the string charge and discharge power instruction value of each of the strings St into n equal parts, and is determined by a resolution. n is a value obtained by dividing a time of the slope control period by the above predetermined cycle.

The string system controller SSC calculates the string charge and discharge power instruction value of each of the strings St for each predetermined cycle in the slope control period of the electricity storage system charge and discharge power, and transmits the calculated string charge and discharge power instruction value to each of the string controllers SC by unicast communication. The string charge and discharge power instruction value is a value obtained by adding the above change amount ΔP1 to a current value that is assumed (hereinafter, referred to as an assumed current value).

After transmitting the string charge and discharge power instruction value to all the string controllers SC, the string system controller SSC transmits a flag for updating the control of the power converters PCS (hereinafter, referred to as a PCS control update flag) to all the string controllers SC by broadcast communication.

When the standard slope control is executed, the string charge and discharge power instruction value of each of the strings St also converges to the target value at the time when the electricity storage system charge and discharge power instruction value converges to the target value. In the subsequent slope control period of the string charge and discharge power, the string charge and discharge power instruction value of each of the strings St gradually changes for the purpose of adjusting a balance of the string charge and discharge power of each of the strings St.

At the time of converging the electricity storage system charge and discharge power instruction value to the target value, the string system controller SSC determines the target value of the string charge and discharge power instruction value of each of the strings St for the purpose of adjusting a balance of the charge and discharge power of each of the strings St. At the same time, the string system controller SSC individually calculates a change amount ΔP2 of the string charge and discharge power instruction value of each predetermined cycle (for example, a cycle of several seconds) for each of the strings St. A method for calculating the change amount ΔP2 is the same as that of the above change amount ΔP1.

The string system controller SSC transmits the string charge and discharge power instruction value of each of the strings St to each of the string controllers SC by unicast communication for each predetermined cycle in the slope control period of the string charge and discharge power. The string charge and discharge power instruction value is a value obtained by adding the above change amount ΔP2 to the assumed current value.

After transmitting the string charge and discharge power instruction value to all the string controllers SC by unicast communication, the string system controller SSC transmits the PCS control update flag to all the string controllers SC by broadcast communication.

As illustrated in the graph of FIG. 4, when the shortest slope control is executed, the electricity storage system charge and discharge power instruction value changes from the current value to the target value over a shorter slope control period (for example, 200 ms to 2 s) than when the standard slope control is executed. In this slope control period, the string charge power instruction value of each of the strings St is updated so as to change from the current value to an intermediate target value in one cycle.

After the electricity storage system charge and discharge power instruction value is updated, the electricity storage system charge and discharge power instruction value is maintained, and the string charge and discharge power instruction value of each of the strings St is updated. The string charge and discharge power instruction value of each of the strings St is updated so as to gradually change from the intermediate target value to a final target value over the slope control period of the string charge and discharge power.

Here, the electricity storage system charge and discharge power instruction value is a total value of the string charge and discharge power instruction values of the respective strings St. Therefore, the string system controller SSC determines the string charge and discharge power instruction value of each of the strings St such that the string charge and discharge power instruction value of each of the strings St changes from the current value to the intermediate target value in one cycle, and the total value of the string charge and discharge power instruction values of the respective strings St changes from the current value to the target value of the electricity storage system charge and discharge power instruction value in one cycle.

The string system controller SSC determines the intermediate target values of the string charge and discharge power instruction values of all the strings St to be the same value uniformly before the start of the slope control period of the electricity storage system charge and discharge power. The string system controller SSC transmits the intermediate target value of the string charge and discharge power instruction value to all the string controllers SC by broadcast communication in the slope control period of the electricity storage system charge and discharge power. Thereafter, the string system controller SSC transmits a PCS control update flag to all the string controllers SC by broadcast communication. The transmission of the PCS control update flag executed by the string system controller SSC to all the string controllers SC in the broadcast communication is not essential.

The string controller SC controls the power converter PCS according to the received intermediate target value of the string charge and discharge power instruction value, and updates the charge and discharge power. Here, for the string St in which the intermediate target value of the string charge and discharge power instruction value exceeds a charge and discharge power upper limit value, the corresponding string controller SC limits the charge and discharge power to be less than the intermediate target value and equal to or less than the charge and discharge power upper limit value. In this case, the total value of the charge and discharge power of the respective strings St is less than the target value of the electricity storage system charge and discharge power. Therefore, in this case, the string system controller SSC corrects the target value of the storage battery system charge and discharge power instruction value in advance in consideration of the charge and discharge power upper limit value received from the string controller SC.

When the shortest slope control is executed, the string charge and discharge power instruction value of each of the strings St converges to the intermediate target value at the time when the electricity storage system charge and discharge power instruction value converges to the target value. Since the intermediate target value deviates from the final target value, the slope control of the string charge and discharge power is executed after the electricity storage system charge and discharge power instruction value converges to the target value. In the slope control period of the string charge and discharge power, the string charge and discharge power instruction value of each of the strings St gradually changes from the intermediate target value to the final target value for the purpose of adjusting a balance of the string charge and discharge power of each of the strings St.

At the time of converging the electricity storage system charge and discharge power instruction value to the target value, the string system controller SSC determines the final target value of the charge and discharge power instruction value of each of the strings St for the purpose of adjusting a balance of the charge and discharge power of each of the strings St. At the same time, the string system controller SSC individually calculates a change amount ΔP3 of the string charge and discharge power instruction value of each predetermined cycle (for example, a cycle of several seconds) for each of the strings St. The change amount ΔP3 is a value obtained by dividing a difference between the intermediate target value and the final target value of the string charge and discharge power instruction value of each of the strings St into n equal parts, and is determined by a resolution.

The string system controller SSC transmits the string charge and discharge power instruction value of each of the strings St to all the string controllers SC by unicast communication for each predetermined cycle in the slope control period of the string charge and discharge power. The string charge and discharge power instruction value is a value obtained by adding the above change amount ΔP3 to the assumed current value.

After transmitting the string charge and discharge power instruction value to all the string controllers SC by unicast communication, the string system controller SSC transmits the PCS control update flag to all the string controllers SC by broadcast communication.

FIG. 5 is a circuit diagram illustrating a communication circuit for performing communication among the string controller SC, the power converter PCS, and the module interface M_{I/F} illustrated in FIGS. 1 and 2. As illustrated in the drawing, the MCU 100 of the module interface M_{I/F} is connected to the string controller SC via a signal line 105, and is connected to the MCU 101 of the power converter PCS via the dedicated signal lines 103 and 104. The MCU 100 of the module interface M_{I/F} is connected to ground (GND) via the signal line 102.

The module interface M_{I/F} includes a first photocoupler PC1 and a second photocoupler PC2. A light emitting diode of the first photocoupler PC1 is connected to the MCU 100 and the GND. A phototransistor of the first photocoupler PC1 is connected to the MCU 101 of the power converter PCS via the signal line 103, and is connected to the GND via the signal line 102. A light emitting diode of the second photocoupler PC2 is connected to the MCU 100 and the GND, and a phototransistor of the second photocoupler PC2 is connected to the MCU 101 of the power converter PCS via the signal line 104 and connected to the GND via the signal line 102.

When the cell voltage transmitted from the cell monitoring unit CMU exceeds the upper limit threshold value, the MCU 100 of the module interface M_{I/F} transmits the cell upper limit voltage warning signal to the light emitting diode of the first photocoupler PC1. When the cell voltage transmitted from the cell monitoring unit CMU falls below the lower limit threshold value, the MCU 100 of the module interface M_{I/F} transmits the cell lower limit voltage warning signal to the light emitting diode of the second photocoupler PC2.

When the cell upper limit voltage warning signal is transmitted from the MCU 100, the first photocoupler PC1 causes the light emitting diode to emit light to make the phototransistor conductive. With respect to this, the first photocoupler PC1 insulates the MCU 100 on the input side from the MCU 101 on the output side while the cell upper limit voltage warning signal is not transmitted from the MCU 100.

When the cell lower limit voltage warning signal is transmitted from the MCU 100, the second photocoupler PC2 causes the light emitting diode to emit light to make the phototransistor conductive. With respect to this, the second photocoupler PC2 insulates the MCU 100 on the input side from the MCU 101 on the output side while the cell lower limit voltage warning signal is not transmitted from the MCU 100.

The signal line 103 is connected to a power supply Vcc via a resistor R1 which is a pull-up resistor. The resistor R1 is connected between a connection point of the first photocoupler PC1 and a connection point of the MCU 101 in the signal line 103. The cell upper limit voltage warning signal is an H-level signal. Therefore, an input potential from the signal line 103 of the MCU 101 becomes the potential of the power supply Vcc while the cell upper limit voltage warning signal is not transmitted, and the input potential from the signal line 103 of the MCU 101 becomes 0 (L-level) while the cell upper limit voltage warning signal is transmitted. The MCU 101 detects the cell upper limit voltage warning signal when the input potential from the signal line 103 decreases from the potential of the power supply Vcc to 0, and controls the power converter PCS such that the charge power of the string St is reduced.

Similarly, the signal line 104 is connected to a power supply Vcc via a resistor R2 which is a pull-up resistor. The resistor R2 is connected between a connection point of the second photocoupler PC2 and a connection point of the MCU 101 in the signal line 104. The cell lower limit voltage warning signal is an H-level signal. Therefore, an input potential from the signal line 104 of the MCU 101 becomes the potential of the power supply Vcc while the cell lower limit voltage warning signal is not transmitted, and the input potential from the signal line 104 of the MCU 101 becomes 0 while the cell lower limit voltage warning signal is transmitted. The MCU 101 detects the cell lower limit voltage warning signal when the input potential from the signal line 104 decreases from the potential of the power supply Vcc to 0, and controls the power converter PCS such that the discharge power of the string St is reduced.

The cell upper limit voltage warning signal and the cell lower limit voltage warning signal do not necessarily have to be H-level signals and may be L-level signals. In this case, while the cell upper limit voltage warning signal or the cell lower limit voltage warning signal is not transmitted, the input potential from the signal line 103 or the signal line 104 of the MCU 101 becomes 0 (L-level), and while the cell upper limit voltage warning signal or the cell lower limit voltage warning signal is transmitted, the input potential from the signal line 103 or the signal line 104 of the MCU 101 becomes the potential of the power supply Vcc. The MCU 101 detects the cell upper limit voltage warning signal or the cell lower limit voltage warning signal when the input potential rises from 0 to the potential of the power supply Vcc, and controls the power converter PCS such that the charge power or the discharge power of the string St is reduced.

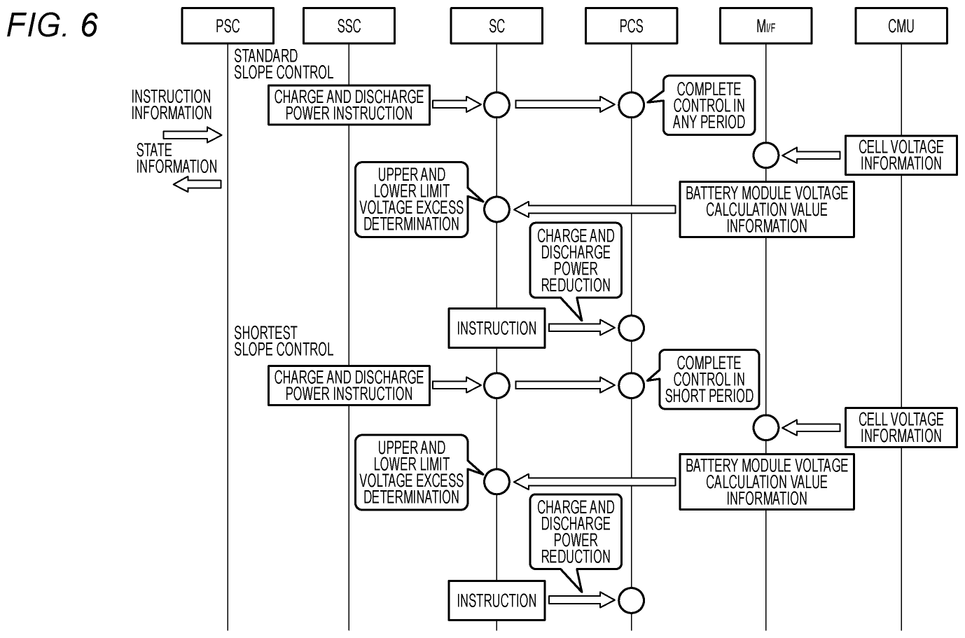

FIG. 6 is a chart illustrating a communication method of a storage battery control device according to a comparative example. Similarly to the storage battery control device 2 according to the embodiment described above, the storage battery control device according to the comparative example includes the electricity storage system controller PSC, the string system controller SSC, the string controller SC, the power converter PCS, the module interface M_{I/F}, and the cell monitoring unit CMU. However, the storage battery control device according to the comparative example is different from the storage battery control device 2 according to the embodiment described above in that the cell upper limit voltage warning signal and the cell lower limit voltage warning signal are not transmitted from the MCU 100 of the module interface M_{I/F} to the MCU 101 of the power converter PCS.

In the storage battery control device according to the comparative example, when the standard slope control and the shortest slope control are executed, the string charge and discharge power instruction value of each of the strings St is transmitted from the string system controller SSC to the string controller SC (charge and discharge power instruction), and the control signal according to the string charge and discharge power instruction value of each of the strings St is transmitted from the string controller SC to the power converter PCS.

Meanwhile, when the standard slope control and the shortest slope control are executed, the cell voltage information is transmitted from the cell monitoring unit CMU to the module interface M_{I/F}, and the voltage of the storage battery of the module M is calculated by the module interface M_{I/F}. The calculated voltage of the storage battery of the module M is transmitted from the module interface M_{I/F} to the string controller SC, and the string controller SC determines whether the voltage is between the upper limit value and the lower limit value (upper and lower limit voltage excess determination). Then, when it is determined that the voltage exceeds the upper limit value, a signal for instructing to reduce the charge power is transmitted from the string controller SC to the power converter PCS, and when it is determined that the voltage falls below the lower limit value, a signal for instructing to reduce the discharge power is transmitted from the string controller SC to the power converter PCS (charge and discharge power reduction).

Here, in the standard slope control, the string charge and discharge power instruction value may gradually change from the current value to the target value in a plurality of (for example, 20) times of cycle processing, and the power converter PCS may complete the control in any period (for example, 100 ms) from the charge and discharge power instruction. Therefore, when the standard slope control is executed, the change amount per unit time in the charge and discharge power of the string St is small. Accordingly, there is a margin in the time from when the cell voltage exceeds the upper limit threshold value to when the cell voltage rises to a cell upper limit voltage (a cell maximum allowable voltage) and the time from when the cell voltage falls below the lower limit threshold value to when the cell voltage falls to a cell lower limit voltage (a cell minimum allowable voltage). Therefore, the cell voltage can be kept between the upper limit value and the lower limit value by the cycle processing from the cell monitoring unit CMU to the string controller SC as illustrated in FIG. 6.

With respect to this, in the shortest slope control, the string charge and discharge power instruction value changes from the current value to the target value in one time of cycle processing, and the power converter PCS needs to complete the control in a short period (for example, 60 ms). Therefore, when the shortest slope control is executed, the change amount per unit time in the charge and discharge power of the string St is large. Accordingly, there is no margin in the time from when the cell voltage exceeds the upper limit threshold value to when the cell voltage rises to the cell upper limit voltage (the cell maximum allowable voltage) and the time from when the cell voltage falls below the lower limit threshold value to when the cell voltage falls to the cell lower limit voltage (the cell minimum allowable voltage). Therefore, it is difficult to keep the cell voltage between the upper limit value and the lower limit value by the cycle processing from the cell monitoring unit CMU to the string controller SC as illustrated in FIG. 6.

Therefore, in the storage battery control device 2 according to the present embodiment, the cell upper limit voltage warning signal and the cell lower limit voltage warning signal are transmitted from the MCU 100 of the module interface M_{I/F} to the MCU 101 of the power converter PCS. Accordingly, the time from the transmission of the cell voltage information of the cell monitoring unit CMU to the response of the charge and discharge power reduction control of the power converter PCS is shortened.

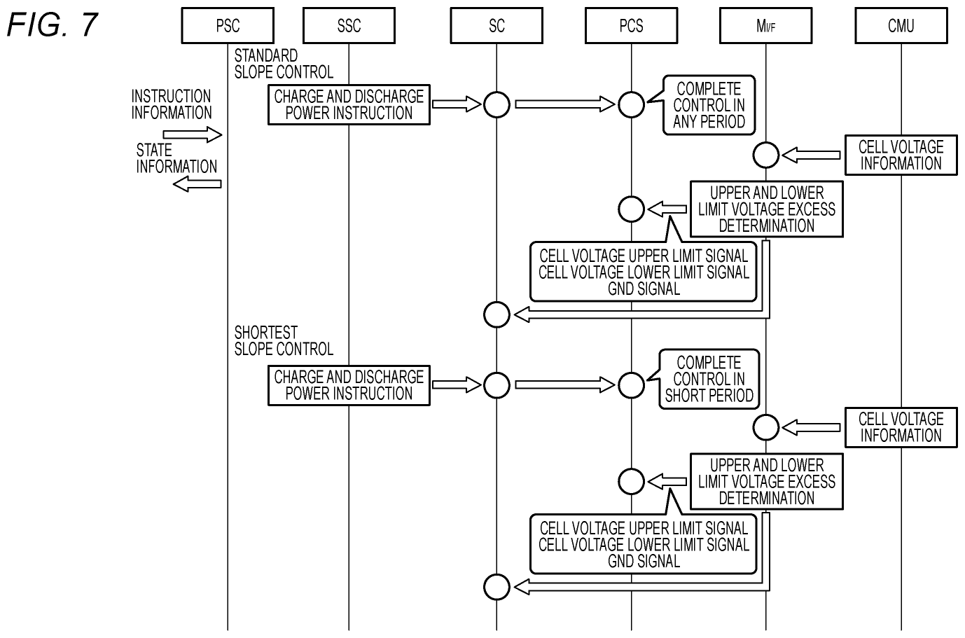

FIG. 7 is a chart illustrating a communication method of the storage battery control device 2 illustrated in FIGS. 1 and 2. In the storage battery control device 2 according to the present embodiment, as in the comparative example, when the standard slope control and the shortest slope control are executed, the string charge and discharge power instruction value is transmitted from the string system controller SSC to the string controller SC (charge and discharge power instruction), and the control signal according to the string charge and discharge power instruction value is transmitted from the string controller SC to the power converter PCS. When the standard slope control is executed, the control is completed in any period (for example, 100 ms) from the charge and discharge power instruction. With respect to this, when the shortest slope control is executed, the power converter PCS completes the control in a short period (for example, 60 ms) from the charge and discharge power instruction.

Meanwhile, when the standard slope control and the shortest slope control are executed, the cell voltage information is transmitted from the cell monitoring unit CMU to the module interface M_{I/F}, and the module interface M_{I/F} determines whether the cell voltage is between the upper limit threshold value and the lower limit threshold value (upper and lower limit voltage excess determination). When the cell voltage exceeds the upper limit threshold value, the cell upper limit voltage warning signal and a GND signal are transmitted from the module interface M_{I/F} to the power converter PCS. When the cell voltage falls below the lower limit threshold value, the cell lower limit voltage warning signal and the GND signal are transmitted from the module interface M_{I/F} to the power converter PCS.

Accordingly, the time from the transmission of the cell voltage information of the cell monitoring unit CMU to the response of the charge and discharge power reduction control of the power converter PCS can be shortened as compared with the comparative example. Therefore, the cell voltage can be kept between the upper limit value and the lower limit value not only when the standard slope control is executed but also when the shortest slope control is executed.

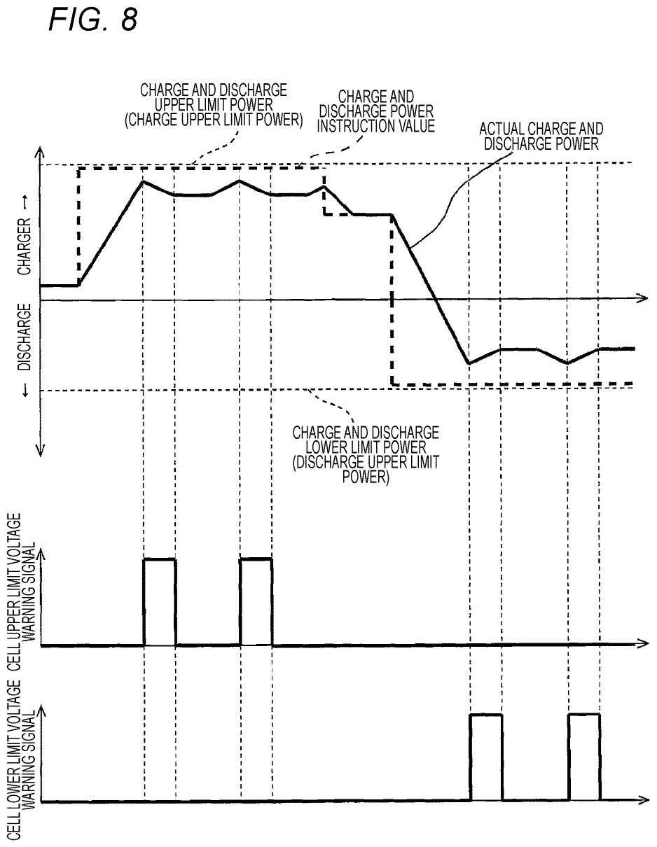

FIG. 8 shows a graph illustrating a transition of the charge and discharge power instruction value and actual charge and discharge power, and timing charts respectively illustrating ON/OFF timings of the cell upper limit voltage warning signal and the cell lower limit voltage warning signal. As illustrated in the graph of FIG. 8, the actual charge and discharge power of each of the strings St changes after the change in the string charge and discharge power instruction value of each of the strings St. During charging, the actual charge power of each of the strings St changes so as to approach the charge power instruction value, and during discharging, the discharge power of each of the strings St changes so as to approach the discharge power instruction value. The charge power instruction value is set to a value lower than the charge and discharge upper limit power of each of the strings St, and the discharge power instruction value is set to a value higher than the charge and discharge lower limit power of each of the strings St.

When the string St is charged, if the cell voltage of the module M in the string St exceeds the upper limit threshold value, the cell upper limit voltage warning signal is transmitted from the module interface M_{I/F}. Here, the upper limit threshold value of the cell voltage is set to a value lower than the upper limit value of the cell voltage (hereinafter, referred to as a cell upper limit voltage). Therefore, when the cell voltage approaches the cell upper limit voltage, the cell upper limit voltage warning signal is transmitted from the module interface M_{I/F} before the cell voltage exceeds the cell upper limit voltage.

While the cell upper limit voltage warning signal is detected by the MCU 101, the charge power of the string St is reduced by the power converter PCS. When the cell upper limit voltage warning signal is not detected by the MCU 101, the charge power of the string St is increased by the power converter PCS so as to approach the charge power instruction value.

When the string St is discharged, if the cell voltage of the module M in the string St falls below the lower limit threshold value, the cell lower limit voltage warning signal is transmitted from the module interface M_{I/F}. Here, the lower limit threshold value of the cell voltage is set to a value higher than the lower limit value of the cell voltage (hereinafter, referred to as a cell lower limit voltage). Therefore, when the cell voltage approaches the cell lower limit voltage, the cell lower limit voltage warning signal is transmitted from the module interface M_{I/F} before the cell voltage falls below the cell lower limit voltage.

While the cell lower limit voltage warning signal is detected by the MCU 101, the discharge power of the string St is reduced by the power converter PCS. When the cell lower limit voltage warning signal is not detected by the MCU 101, the discharge power of the string St is increased by the power converter PCS so as to approach the discharge power instruction value.

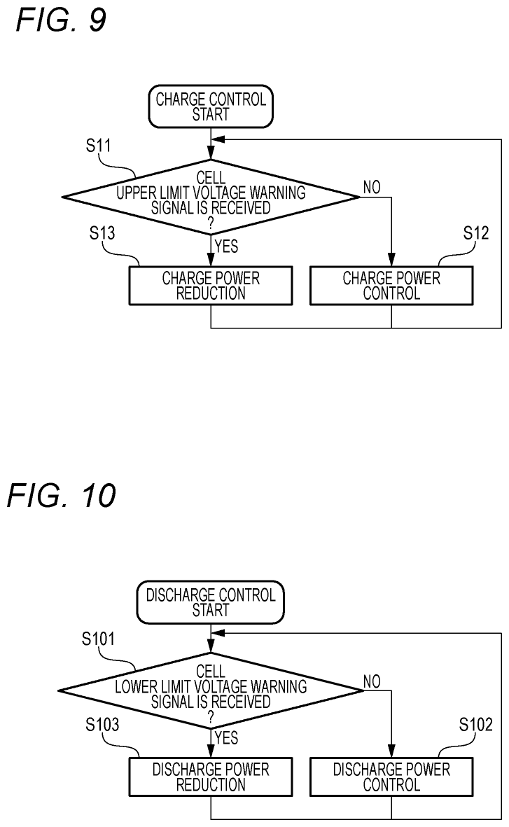

FIG. 9 is a flowchart illustrating a charge control of the storage battery control device 2 illustrated in FIGS. 1 and 2. As illustrated in this flowchart, when the charge control of the electricity storage system 1 is started, the MCU 101 of the power converter PCS determines whether the cell upper limit voltage warning signal is received (step S11). In this step, the MCU 101 determines whether the input potential from the signal line 103 is 0 (L-level).

When the MCU 101 does not receive the cell upper limit voltage warning signal (NO in step S11), the MCU 101 controls the power converter PCS such that the charge power of the string St approaches the charge power instruction value (charge power control in step S12). With respect to this, when the MCU 101 receives the cell upper limit voltage warning signal (YES in step S11), the MCU 101 controls the power converter PCS such that the charge power of the string St is reduced (charge power reduction in step S13).

By repeating steps S11 to S13 described above, the increase of the charge power of the string St to approach the charge power instruction value and the decrease of the charge power of the string St to reduce the cell voltage to be less than the cell upper limit voltage are repeated.

FIG. 10 is a flowchart illustrating a discharge control of the storage battery control device 2 illustrated in FIGS. 1 and 2. As illustrated in this flowchart, when the discharge control of the electricity storage system 1 is started, the MCU 101 of the power converter PCS determines whether the cell lower limit voltage warning signal is received (step S101). In this step, the MCU 101 determines whether the input potential from the signal line 104 is 0 (L-level).

When the MCU 101 does not receive the cell lower limit voltage warning signal (NO in step S101), the MCU 101 controls the power converter PCS such that the discharge power of the string St approaches the discharge power instruction value (discharge power control in step S102). With respect to this, when the MCU 101 receives the cell lower limit voltage warning signal (YES in step S101), the MCU 101 controls the power converter PCS such that the discharge power of the string St is reduced (discharge power reduction in step S103).

By repeating steps S101 to S103 described above, the increase of the discharge power of the string St to approach the discharge power instruction value and the decrease of the discharge power of the string St to make the cell voltage to be higher than the cell lower limit voltage are repeated.

As described above, in the storage battery control device 2 according to the present embodiment, the MCU 100 of the module interface M_{I/F} receives the detection signal of the cell voltage from the cell monitoring unit CMU, and transmits the charge reduction signal for reducing the charge power of the string St to the MCU 101 of the power converter PCS when the cell voltage is equal to or larger than the upper limit threshold value. The MCU 101 controls the power converter PCS such that the charge power of the string St approaches the charge power instruction value while receiving the control signal corresponding to the charge power instruction value from the string controller SC and not receiving the charge reduction signal from the MCU 100 of the module interface M_{I/F}. With respect to this, the MCU 101 controls the power converter PCS such that the charge power of the string St is reduced while receiving the control signal from the string controller SC and receiving the charge reduction signal from the MCU 100 of the module interface M_{I/F}.

Accordingly, it is possible to prevent a communication delay from the transmission of the cell voltage information executed by the cell monitoring unit CMU to the response of the charge power reduction control executed by the power converter PCS. Therefore, in the electricity storage system 1 in which the performance of the storage battery cells C in the string St varies, it is possible to control the charge of the string St in a state in which the cell voltage is maintained below the upper limit value.

In the storage battery control device 2 according to the present embodiment, the MCU 100 of the module interface M_{I/F} receives the detection signal of the cell voltage from the cell monitoring unit CMU, and transmits the discharge reduction signal for reducing the discharge power of the string St to the MCU 101 of the power converter PCS when the cell voltage is equal to or larger than the lower limit threshold value. The MCU 101 controls the power converter PCS such that the discharge power of the string St approaches the discharge power instruction value while receiving the control signal corresponding to the discharge power instruction value from the string controller SC and not receiving the discharge reduction signal from the MCU 100 of the module interface M_{I/F}. With respect to this, the MCU 101 controls the power converter PCS such that the discharge power of the string St is reduced while receiving the control signal from the string controller SC and receiving the discharge reduction signal from the MCU 100 of the module interface M_{I/F}.

Accordingly, it is possible to prevent a communication delay from the transmission of the cell voltage information executed by the cell monitoring unit CMU to the response of the discharge power reduction control executed by the power converter PCS. Therefore, in the electricity storage system 1 in which the performance of the storage battery cells C in the string St varies, it is possible to control the discharge of the string St in a state in which the cell voltage is maintained higher than the lower limit value.

The storage battery control device 2 according to the present embodiment includes the first photocoupler PC1 provided on the signal line 103 connecting the MCU 100 of the module interface M_{I/F} and the MCU 101 of the power converter PCS, and the resistor R1 as a pull-up resistor connected between the first photocoupler PC1 and the MCU 101 in the signal line 103. This makes it possible to transmit the cell upper limit voltage warning signal from the MCU 100 to the first photocoupler PC1 while electrically insulating the MCU 100 from the MCU 101.

The storage battery control device 2 according to the present embodiment includes the second photocoupler PC2 provided on the signal line 104 connecting the MCU 100 of the module interface M_{I/F} and the MCU 101 of the power converter PCS, and the resistor R2 as a pull-up resistor connected between the second photocoupler PC2 and the MCU 101 in the signal line 103. This makes it possible to transmit the cell lower limit voltage warning signal from the MCU 100 to the second photocoupler PC2 while electrically insulating the MCU 100 from the MCU 101.

Although the present disclosure has been described above based on the above embodiment, the present disclosure is not limited to the above embodiment. Modifications may be made without departing from the gist of the present disclosure, or publicly known or well-known techniques may be appropriately combined.

For example, in the above-described embodiment, the MCU 100 of the module interface M_{I/F} and the MCU 101 of the power converter PCS can be insulated from each other by the first photocoupler PC1 and the second photocoupler PC2, but it is not essential. Further, although the cell upper limit voltage warning signal and the cell lower limit voltage warning signal are transmitted using the respective photocouplers (the first photocoupler PC1 and the second photocoupler PC2) and the respective signal lines 103 and 104, the present disclosure is not limited thereto, and the cell upper limit voltage warning signal and the cell lower limit voltage warning signal may be transmitted using one photocoupler and one signal line. In this case, the MCU 101 receives the cell upper and lower limit voltage warning signal, but the MCU 101 can perform the charge and discharge power reduction control because the MCU 101 knows which of the charge and discharge is controlled by the MCU 101.

In the above-described embodiment, the string system controller SSC transmits the string charge and discharge power instruction value to the string controllers SC. However, the electricity storage system controller PSC and the string system controller SSC may be integrated into one controller, and the integrated controller may transmit the string charge and discharge power instruction value to the string controllers SC. In addition, any of the plurality of string controllers SC may be a master controller and the others may be slave controllers, and the master controller may transmit the string charge and discharge power instruction value to the slave controllers.

Here, features of embodiments of the storage battery control device and the electricity storage system according to the present disclosure described above will be briefly summarized and listed in the following the aspects 1 to 4.

According to the aspect 1 of the present disclosure, there is provided a storage battery control device (2) for controlling an electricity storage system (1), the electricity storage system (1) including a string (St, St1 to Stx) including a plurality of storage battery modules (M, M1 to Mn) connected in series, and a power converter (PCS, PCS1 to PCSx) configured to convert charge and discharge power of the string (St, St1 to Stx), the storage battery modules (M, M1 to Mn) each including a plurality of storage battery cells (C) connected in series, and a cell voltage detection unit (CMU, CMU1 to CMUn) configured to detect a voltage of each of the storage battery cells (C). The storage battery control device (2) includes:
a plurality of module control units (100) provided respectively corresponding to the storage battery modules (M, M1 to Mn), and configured to control the storage battery modules (M, M1 to Mn);
a power converter control unit (101) configured to control the power converter (PCS, PCS1 to PCSx); and
a string control unit (SC, SC1 to SCx) provided corresponding to the string (St, St1 to Stx), and configured to communicate with the plurality of module control units (100), the power converter control unit (101), and a host control unit (SSC), and transmit a control signal to the power converter control unit (101) for controlling the power converter (PCS, PCS1 to PCSx) such that charge power of the string (St, St1 to Stx) approaches a charge power instruction value received from the host control unit (SSC), in which
each of the module control units (100) is configured to receive a detection signal of the voltage of the storage battery cell (C) from the cell voltage detection unit (CMU, CMU1 to CMUn), and transmit a charge reduction signal for reducing the charge power of the string (St, St1 to Stx) to the power converter control unit (101) when the voltage of the storage battery cell (C) is equal to or larger than an upper limit threshold value, and
the power converter control unit (101) is configured to control the power converter (PCS, PCS1 to PCSx) to bring the charge power of the string (St, St1 to Stx) close to the charge power instruction value while receiving the control signal from the string control unit (SC, SC1 to SCx) and not receiving the charge reduction signal from the module control unit (100), and control the power converter (PCS, PCS1 to PCSx) to reduce the charge power of the string (St, St1 to Stx) while receiving the control signal from the string control unit (SC, SC1 to SCx) and receiving the charge reduction signal from the module control unit (100).

According to the aspect 2 of the present disclosure, there is provided a storage battery control device (2) for controlling an electricity storage system (1), the electricity storage system (1) including a string (St, St1 to Stx) including a plurality of storage battery modules (M, M1 to Mn) connected in series, and a power converter (PCS, PCS1 to PCSx) configured to convert charge and discharge power of the string (St, St1 to Stx), the storage battery modules (M, M1 to Mn) each including a plurality of storage battery cells (C) connected in series, and a cell voltage detection unit (CMU, CMU1 to CMUn) configured to detect a voltage of each of the storage battery cells (C). The storage battery control device (2) includes:
a plurality of module control units (100) provided respectively corresponding to the storage battery modules (M, M1 to Mn), and configured to control the storage battery modules (M, M1 to Mn);
a power converter control unit (101) configured to control the power converter (PCS, PCS1 to PCSx); and
a string control unit (SC, SC1 to SCx) provided corresponding to the string (St, St1 to Stx), and configured to communicate with the plurality of module control units (100), the power converter control unit (101), and a host control unit (SSC), and transmit a control signal to the power converter control unit (101) for controlling the power converter (PCS, PCS1 to PCSx) such that discharge power of the string (St, St1 to Stx) approaches a discharge power instruction value received from the host control unit (SSC), in which
each of the module control units (100) is configured to receive a detection signal of the voltage of the storage battery cell (C) from the cell voltage detection unit (CMU, CMU1 to CMUn), and transmit a discharge reduction signal for reducing the discharge power of the string (St, St1 to Stx) to the power converter control unit (101) when the voltage of the storage battery cell (C) is equal to or less than a lower limit threshold value, and
the power converter control unit (101) is configured to control the power converter (PCS, PCS1 to PCSx) to bring the discharge power of the string (St, St1 to Stx) close to the discharge power instruction value while receiving the control signal from the string control unit (SC, SC1 to SCx) and not receiving the discharge reduction signal from the module control unit (100), and control the power converter (PCS, PCS1 to PCSx) to reduce the discharge power of the string (St, St1 to Stx) while receiving the control signal from the string control unit (SC, SC1 to SCx) and receiving the discharge reduction signal from the module control unit (100).

According to the aspect 3 of the present disclosure, the storage battery control device (2) according to the aspect 1 or 2 further includes:
a photocoupler (PC1, PC2) provided on a signal line (103, 104) connecting the module control unit (100) and the power converter control unit (101); and
a pull-up resistor (R1, R2) connected between the photocoupler (PC1, PC2) and the power converter control unit (101) on the signal line (103, 104).

According to the aspect 4 of the present disclosure, there is provided an electricity storage system (1) including:
a string (St, St1 to Stx) including a plurality of storage battery modules (M, M1 to Mn) connected in series;
a power converter (PCS, PCS1 to PCSx) configured to convert charge and discharge power of the string (St, St1 to Stx), the storage battery modules (M, M1 to Mn) each including a plurality of storage battery cells (C) connected in series, and a cell voltage detection unit (CMU, CMU1 to CMUn) configured to detect a voltage of each of the storage battery cells (C); and
the storage battery control device (2) according to the aspect 1 or 2.

Although the present disclosure is described in detail and with reference to the specific embodiments, it is apparent to those skilled in the art that various changes and modifications can be made without departing from the spirit and scope of the present disclosure.

The present application is based on a Japanese patent application (Japanese Patent

Application No. 2024-001574) filed on Jan. 10, 2024, and the contents thereof are incorporated herein by reference.

What is claimed is:

1. A storage battery control device for controlling an electricity storage system, the electricity storage system including a string including a plurality of storage battery modules connected in series, and a power converter configured to convert charge and discharge power of the string, the storage battery modules each including a plurality of storage battery cells connected in series, and a cell voltage detection unit configured to detect a voltage of each of the storage battery cells, the storage battery control device comprising:
a plurality of module control units provided respectively corresponding to the storage battery modules, and configured to control the storage battery modules;
a power converter control unit configured to control the power converter; and
a string control unit provided corresponding to the string, and configured to communicate with the plurality of module control units, the power converter control unit, and a host control unit, and transmit a control signal to the power converter control unit for controlling the power converter such that charge power of the string approaches a charge power instruction value received from the host control unit, wherein
each of the module control units is configured to receive a detection signal of the voltage of the storage battery cell from the cell voltage detection unit, and transmit a charge reduction signal for reducing the charge power of the string to the power converter control unit when the voltage of the storage battery cell is equal to or larger than an upper limit threshold value, and
the power converter control unit is configured to control the power converter to bring the charge power of the string close to the charge power instruction value while receiving the control signal from the string control unit and not receiving the charge reduction signal from the module control unit, and control the power converter to reduce the charge power of the string while receiving the control signal from the string control unit and receiving the charge reduction signal from the module control unit.

2. A storage battery control device for controlling an electricity storage system, the electricity storage system including a string including a plurality of storage battery modules connected in series, and a power converter configured to convert charge and discharge power of the string, the storage battery modules each including a plurality of storage battery cells connected in series, and a cell voltage detection unit configured to detect a voltage of each of the storage battery cells, the storage battery control device comprising:
a plurality of module control units provided respectively corresponding to the storage battery modules, and configured to control the storage battery modules;
a power converter control unit configured to control the power converter; and
a string control unit provided corresponding to the string, and configured to communicate with the plurality of module control units, the power converter control unit, and a host control unit, and transmit a control signal to the power converter control unit for controlling the power converter such that discharge power of the string approaches a discharge power instruction value received from the host control unit, wherein
each of the module control units is configured to receive a detection signal of the voltage of the storage battery cell from the cell voltage detection unit, and transmit a discharge reduction signal for reducing the discharge power of the string to the power converter control unit when the voltage of the storage battery cell is equal to or less than a lower limit threshold value, and
the power converter control unit is configured to control the power converter to bring the discharge power of the string close to the discharge power instruction value while receiving the control signal from the string control unit and not receiving the discharge reduction signal from the module control unit, and control the power converter to reduce the discharge power of the string while receiving the control signal from the string control unit and receiving the discharge reduction signal from the module control unit.

3. The storage battery control device according to claim 1, further comprising:
a photocoupler provided on a signal line connecting the module control unit and the power converter control unit; and
a pull-up resistor connected between the photocoupler and the power converter control unit on the signal line.

4. An electricity storage system comprising:
a string including a plurality of storage battery modules connected in series;
a power converter configured to convert charge and discharge power of the string, the storage battery modules each including a plurality of storage battery cells connected in series, and a cell voltage detection unit configured to detect a voltage of each of the storage battery cells; and
the storage battery control device according to claim 1.

5. The storage battery control device according to claim 2, further comprising:
a photocoupler provided on a signal line connecting the module control unit and the power converter control unit; and
a pull-up resistor connected between the photocoupler and the power converter control unit on the signal line.

6. An electricity storage system comprising:
a string including a plurality of storage battery modules connected in series;
a power converter configured to convert charge and discharge power of the string, the storage battery modules each including a plurality of storage battery cells connected in series, and a cell voltage detection unit configured to detect a voltage of each of the storage battery cells; and
the storage battery control device according to claim 2.
